(19) United States
(12) Patent Application Publication
(10) Pub. No.: US 2006/0066587 A1
(43) Pub. Date: Mar. 30, 2006

(54) Electronic apparatus and touch pad device

(76) Inventors: Toshihiro Morohoshi, Kawasaki-shi (JP); Hidehito Izawa, Hanno-shi (JP); Kazuhiro Takashima, Tokyo (JP); Masao Iwasaki, Fuchu-shi (JP); Hitoshi Suzuki, Hino-shi (JP)

Correspondence Address: DLA PIPER RUDNICK GRAY CARY US LLP, P. O. BOX 9271, RESTON, VA, 20195, US

(21) Appl. No.: 11/221,140

(22) Filed: Sep. 6, 2005

(30) Foreign Application Priority Data
Sep. 24, 2004 (JP) 2004-277994

(51) Int. Cl. G09G 5/00

(52) U.S. Cl. 345/173

(57) ABSTRACT

An electronic apparatus includes a touch pad having an operation surface formed by a first surface extending vertically or horizontally, and a second surface which is contiguous to the first surface at right angles, a detection unit which detects the operation position and the operation direction of a touch operation made on the operation surface of the touch pad, and a display panel which displays the detection content detected by the detection unit.

### CROSS-REFERENCE TO RELATED APPLICATIONS

This application is based upon and claims the benefit of priority from prior Japanese Patent Application No. 2004-277994, filed Sep. 24, 2004, the entire contents of which are incorporated herein by reference.

### BACKGROUND OF THE INVENTION

1. Field of the Invention

The present invention relates to a portable electronic apparatus having a touch pad device.

2. Description of the Related Art

In notebook computers, as disclosed in, e.g., Jpn. Pat. Appln. KOKAI Publication No. 2000-181617, touch pads are popularly used as pointing devices. In handheld portable apparatuses such as game machines or the like, sets of descrete switches at end points of overlying cross-cursor buttons are used as operation input means.

Since the aforementioned touch pad has a rectangular operation surface, and allows pointing operations on a two-dimensional plane, it requires a relatively broad operation surface.

Therefore, when such a touch pad is applied to a portable, compact electronic apparatus, problems of mounting area, cost, and the like are posed. When up/down (back/forth) and right/left cursor instruction operations are to be made, since the touch pad has a rectangular two-dimensional plane, the degree of freedom in operation is large, and it is difficult to clearly associate instructions and operations, resulting in poor operability. Since the cross-cursor button is used to input instructions by means of a limited number of switches at respective end points of the cross-cursor button, and not by means of a touch pad, it has limited functionality for operation inputs on various windows.

### BRIEF SUMMARY OF THE INVENTION

The present invention has been made in consideration of the above situation, and has as its object to provide an electronic apparatus and a touch pad device, which can have a small mounting area, and realize an operation input mechanism which has excellent operability and functionality.

According to the present invention, there is provided an electronic apparatus comprising a touch pad having an operation surface formed by a first elongated surface, and a second elongated surface which is contiguous and transverse to the first surface, a detection unit which detects the position and direction of operation on the operation surface of the touch pad, and a display panel which displays the result of the detection unit.

Also, according to the present invention, there is provided a touch pad device comprising a touch pad having an operation surface formed by a first elongated surface, and a second elongated surface which is contiguous and transverse to the first surface.

The aforementioned electronic apparatus and touch pad device can have a small mounting area, and provide an operation input mechanism which has excellent operability and functionality.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below serve to explain the principles of the invention.

FIG. 1 is an external view showing an example of the arrangement of the front surface of an electronic apparatus according to a first embodiment of the present invention;

FIG. 2 is an external view showing an example of the arrangement of the right side surface of the electronic apparatus according to the first embodiment of the present invention;

FIG. 3 is an external view showing an example of the arrangement of the top surface of the electronic apparatus according to the first embodiment of the present invention;

FIG. 4 is an external view showing an example of the arrangement of the bottom surface of the electronic apparatus according to the first embodiment of the present invention;

FIG. 5 is a block diagram showing an example of the system arrangement of the electronic apparatus according to the first embodiment;

FIG. 6 is a flowchart showing the processing sequence for determining the type of operation input in the first embodiment;

FIG. 7 is a flowchart showing the sequence of a button depression process in the first embodiment;

FIG. 8 is a flowchart showing movement detection in the first embodiment;

FIG. 9 is a view for explaining an example of an operation according to the first embodiment;

FIG. 10 is a view for explaining another example of an operation according to the first embodiment;

FIG. 11 is a view for explaining still another example of an operation according to the first embodiment;

FIG. 12 is an external view showing an example of the arrangement of the front surface of an electronic apparatus according to a second embodiment of the present invention;

FIG. 13 is an external view showing an example of the arrangement of the front surface of an electronic apparatus according to a third embodiment of the present invention;

FIG. 14 is an external view showing an example of the arrangement of the front surface of an electronic apparatus according to a fourth embodiment of the present invention;

FIG. 15 is an external view showing an example of the arrangement of the front surface of an electronic apparatus according to a fifth embodiment of the present invention; and

FIG. 16 is an external view showing an example of the arrangement of the front surface of an electronic apparatus according to a sixth embodiment of the present invention.

### DETAILED DESCRIPTION OF SEVERAL EMBODIMENTS

Preferred embodiments of the present invention will be described hereinafter with reference to the accompanying drawings.

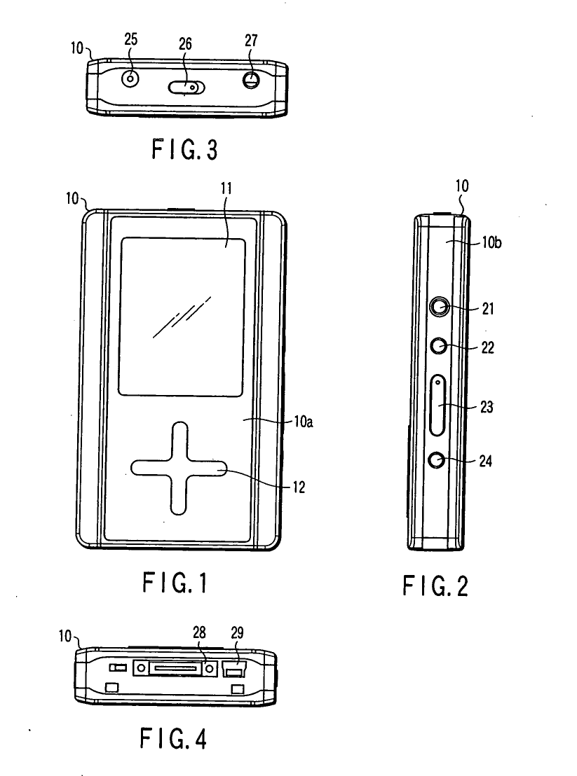

FIGS. 1 to 4 are external views showing an example of the arrangement of an electronic apparatus according to a first embodiment of the present invention. FIG. 1 is a front view, FIG. 2 is a right side view, FIG. 3 is a top view, and FIG. 4 is a bottom view. In this case, a digital audio player is exemplified.

The digital audio player according to the embodiment of the present invention has a display panel 11 and touch pad 12 on a housing front surface 10a of a main body 10, as shown in FIG. 1. As shown in FIG. 2, the digital audio player has a power ON/OFF button 21, menu select button 22, volume control button 23, user select button 24, and the like on one side surface 10b of the housing of the main body 10. As shown in FIG. 3, the digital audio player has a connection terminal 25 of an AC adapter power supply, a hold switch 26, a headphone terminal 27, and the like on the top surface of the main body 10. As shown in FIG. 4, the digital audio player has a cradle interface connector 28, USB terminal 29, and the like on the bottom surface of the main body 10.

The display panel 11 comprises a color LCD which displays and outputs various selection/operation windows including vertical and horizontal scroll windows used to operate this player together with a cursor under the control of a processor to be described later.

The touch pad 12 has an operation surface defined by a first elongated surface and a second elongated surface. The first elongated surface can extend vertically or horizontally, or in any direction. The second elongated surface is contiguous with and transverse to (e.g., perpendicular to) the first surface. In this embodiment, the touch pad 12 has a structure having a cross-shaped operation surface (pad surface) formed by largely trimming four corners of a rectangular touch pad. The touch pad 12 having this cross-shaped operation surface (pad surface) need not have a large number of arrays of sensing units in a two-dimensional matrix, and can be realized by pressure sensitive element arrays having seven sensing units in both the vertical and horizontal directions.

The cross-shaped touch pad 12 forms an operation input unit which allows the user to intuitively make up/down (back/forth) and right/left two-dimensional cursor instruction operations on the operation window of the display panel 11. Also, the touch pad 12 can be implemented with a structure requiring a smaller number of sensor arrays. Furthermore, the mounting area occupied by the touch pad 12 on the front surface 10a of the housing can be minimized.

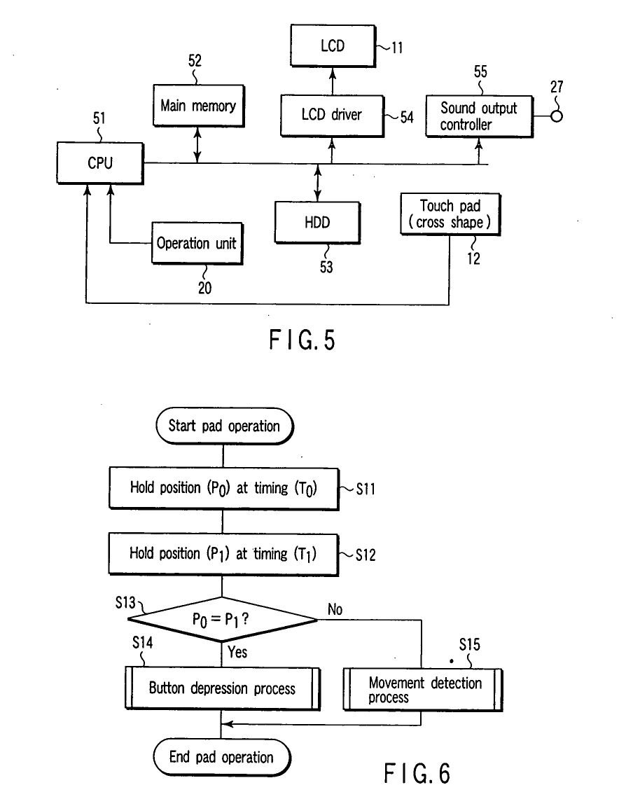

FIG. 5 shows an example of the system arrangement of the digital audio player shown in FIGS. 1 to 4.

The digital audio player comprises building components such as a CPU 51, main memory 52, hard disk drive (HDD) 53, LCD driver 54, sound output controller 55, and the like, in addition to the components shown in FIGS. 1 to 4. Operation unit 20 includes various operation buttons and operation switches including the power ON/OFF button 21, menu select button 22, volume control button 23, use select button 24, and the like shown in FIGS. 1 to 4.

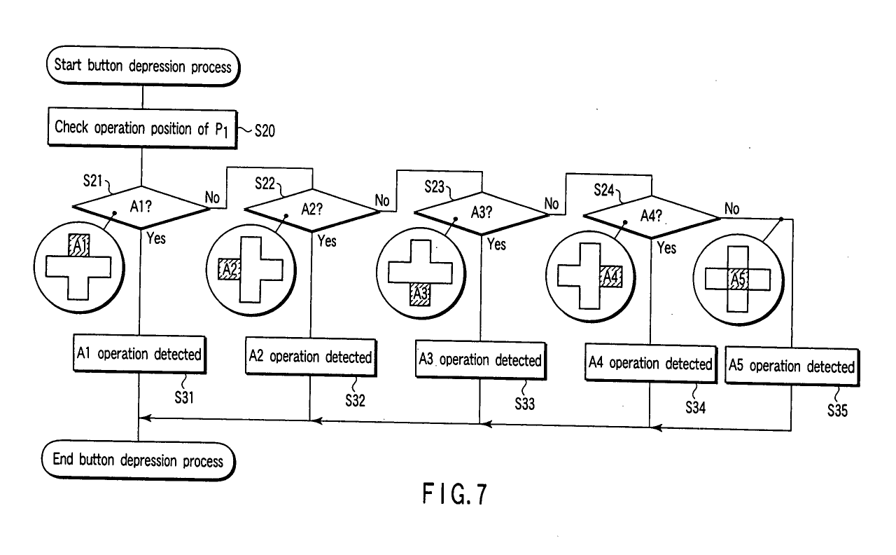

The CPU 51 includes a processor that controls the overall digital audio player of this embodiment according to a program stored in the main memory 52. In this embodiment, the CPU 51 implements a process for effecting playback control by outputting sound data stored in the hard disk drive (HDD) 53 to the sound output controller 55, and then outputting it to the headphone terminal 27 in accordance with instructions from the operation unit 20. In this process, the CPU 51 executes operation input processes shown in FIGS. 6 to 8 in accordance with operations on the touch pad 12.

The LCD driver 54 displays and outputs various operation windows on the display panel 11 under the control of the CPU 51. The LCD driver 54 displays input/output operation windows of sound (audio) data, playback sound select windows, and the like including vertical and horizontal scroll windows operated by the touch pad 12 together with a cursor.

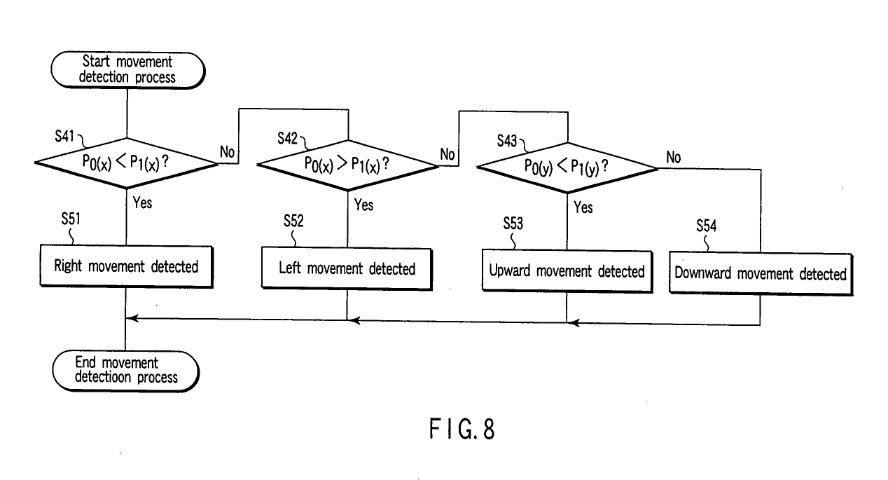

FIGS. 6 to 8 show the sequences of operation input processes to be executed by the CPU 51 upon operation of the touch pad 12. FIG. 6 shows the sequence of a type determination process for determining the type of operation input upon operation of the touch pad 12. FIG. 7 shows the sequence of a button depression operation. FIG. 8 shows the sequence of a movement detection process.

In this embodiment, the operation surface of the touch pad 12 is divided into a plurality of regions which extend in different directions from a joint portion of the first surface extending vertically or horizontally, and the second surface which is perpendicularly contiguous with the first surface (in this embodiment, since the operation surface has a cross shape, they are four, upper, lower, right, and left regions), and a region formed on the joint portion (in this embodiment, since the operation surface has a cross shape, this is a central region). The operation surface of touch pad 12 is provided with a function of detecting a position and operation count by means of touch operations (button depression operation) for each of these regions (in this embodiment, since the operation surface has a cross shape, they are five regions). As shown in FIG. 7, of the five operation regions on the operation surface of the touch pad 12, the upper region is called the A1 region, the left region is called the A2 region, the lower region is called the A3 region, the right region is called the A4 region, and the central region is called the A5 region.

When the touch pad 12 is operated, the CPU 51 first executes a type determination process shown in FIG. 6. In the process shown in FIG. 6, the operation position is detected at a given sense timing. More specifically, the operation position is detected at a sense timing (T₀) at the beginning of the pad operation, and that detected position data (P₀) is temporarily held (step S11). The operation position is detected at the next sense timing (T₁), and that detected position data (P₁) is temporarily held (step S12). The detected position data (P₀) detected at the sense timing (T₀) is compared with the detected position data (P₁) detected at the sense timing (T₁) (step S13).

If the detected position data (P₀) detected at the sense timing (T₀) and the detected position data (P₁) detected at the sense timing (T₁) have an identical value (identical position) (step S13: YES), a button depression operation is determined, and the button depression process shown in FIG. 7 is executed (step S14).

On the other hand, if the detected position data (P₀) detected at the sense timing (T₀) and the detected position data (P₁) detected at the sense timing (T₁) are different (step S13: NO), a movement operation is determined, and the movement detection process shown in FIG. 8 is executed (step S15).

In the button depression process (step S14), as shown in FIG. 7, the operation position of the touch pad 12 is checked based on the detected position data (P₁ or P₀) (step S20) to determine the operation region (step S21, S22, S23, or S24).

If it is detected that the A1 region is operated (step S21: YES), that button depression detection is reflected in an application process which is being executed (step S31). In this case, the button operation is reflected in the cursor operation, or input/output operation windows of sound (audio) data, playback sound select windows, and the like including vertical and horizontal scroll windows, which are displayed on the display panel 11. When the application process requires an operation count, that operation count is held (an operation count=1 since the first detection is made). In this case, when the operation on the A1 region is detected again in the next button depression process, the operation count is incremented (by +1).

If it is detected in steps S22 to S24 that one of the A2 to A5 regions is operated, that button operation is similarly reflected in the application (steps S32 to S35).

On the other hand, in the movement detection process (step S15 in FIG. 6), the detected position data (P₀) detected at the sense timing (T₀) and the detected position data (P₁) detected at the sense timing (T₁) are compared to determine a movement in the horizontal direction (A2-A5-A4) or the vertical direction (A1-A5-A3) in step S41, S42, or S43 in FIG. 8, thus detecting the direction. Note that the detected position data (P₀, P₁) are represented by (P₀(x), P₁(x)) when the movement is in the horizontal direction, and by (P₀(y), P₁(y)) when the movement is in the vertical direction.

If the movement is in the horizontal direction, and the value of the detected position data (P₁(x)) is larger than that of the detected position data (P₀(x)) (P₀(x)<P₁(x)) (step S41: YES), a right movement (tracing the operation surface of the touch pad 12 with the finger in the right direction) is determined, and the operation detection output according to that determination result is reflected in the application process which is being executed (step S51).

On the other hand, if the movement is in the horizontal direction, and the value of the detected position data (P₁(x)) is smaller than that of the detected position data (P₀(x)) (P₀(x)>P₁(x)) (step S42: YES), a left movement (tracing the operation surface of the touch pad 12 with the finger in the left direction) is determined, and the operation detection output according to that determination result is reflected in the application process which is being executed (step S52).

If the movement is in the vertical direction, and the value of the detected position data (P₁(y)) is larger than that of the detected position data (P₀(y)) (P₀(y)<P₁(y)) (step S43: YES), an upward movement (tracing the operation surface of the touch pad 12 with the finger in the upper direction) is determined, and the operation detection output according to that determination result is reflected in the application process which is being executed (step S53). If the movement is in the vertical direction, and the value of the detected position data (P₁(y)) is smaller than that of the detected position data (P₀(y)) (P₀(y)>P₁(y)) (step S43: NO), a downward movement (tracing the operation surface of the touch pad 12 with the finger in the lower direction) is determined, and the operation detection output according to that determination result is reflected in the application process which is being executed (step S54).

In this process, the amount and speed of movement of the finger on the operation surface of the touch pad 12 can be detected. The amount of movement can be ascertained by simply detecting the operation regions in the horizontal or vertical direction, and the speed of movement can be ascertained by detecting the operation amount in the horizontal or vertical direction between the sense timings.

In this way, the user can arbitrarily select the button depression operation by touching the operation surface of the touch pad 12 and the movement operation by tracing the operation surface of the touch pad 12 and can continuously make the selected operations in the flow of a series of finger operations. The user can intuitively make this gesture operation on the cross-shaped operation surface.

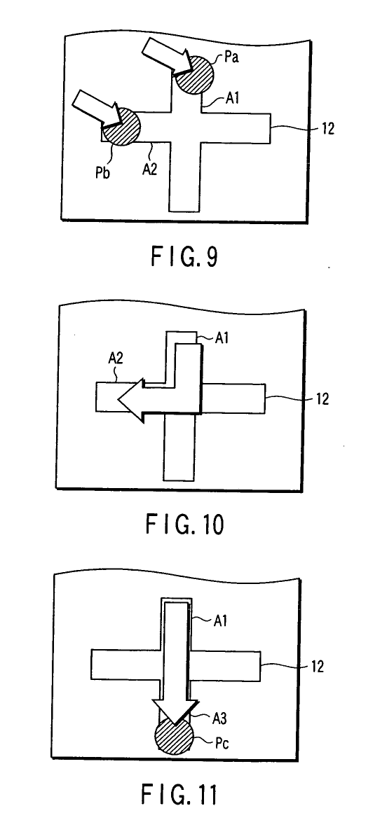

Application examples of the operation in the embodiment of the present invention will be explained below with reference to FIGS. 9 to 11. The touch pad 12 shown in FIGS. 9 to 11 performs an operation equivalent to depression of a switch according to the position where the user touches the cross-shaped operation surface. When the user traces the cross-shaped operation surface, the tracing operation is recognized, and a command different from depression of a switch (e.g., “up-to-down slow move”, “right-to-left quick move”) can be issued. When the movement of the cursor position on the display panel 11 is assigned to that command, the moving speed of the cursor on the display panel 11 can be changed depending on the speed or position of the finger that moves on the operation surface of the touch pad 12.

An operation will be described below taking a pad operation in the vertical direction as an example. When the user moves the finger on the operation surface of the touch pad 12 relatively slowly for, e.g., 1 sec or more, and five lines are displayed on the window of the display panel 11, the cursor position can be moved for five lines from the upper end to the lower end in the window; when the user moves the finger at a relatively high speed within 1 sec, the cursor position can be moved over 10 or 20 lines. In case of up-to-down movement using only the upper half on the operation surface of the touch pad 12, a function of moving the cursor position for five lines from the upper end to the lower end in the window may be assigned, and in case of movement using the entire window from its upper half to its lower half, a function of quickly moving the cursor position may be assigned.

When the user successively traces the touch pad 12, the moving speed may be further increased. In this case, the successive tracing operations are determined when the user completes the first up-to-down tracing operation and then makes the next tracing operation in the same direction within N sec. The value N is, e.g., 0.5 to 1 sec. When the number of items which are actually displayed is smaller than the number of items to be displayed, speeding up is a very effective operation. When the cursor is moved quickly, an operation (inertial movement) for moving the cursor for a while after quitting tracing of the finger can also be made. This makes it possible for moving the cursor quickly and continuously without increasing the numbers of tracing of the finger. As shown in FIG. 11, when the finger is kept placed at the lower end (Pc) after the tracing operation is made from the top (A1 region) to the bottom (A3 region), the tracing operation can be continued.

Examples of the input method according to the operations of the touch pad 12 will be described below. Normally, operations are made using only the vertical or horizontal direction of the cross shape or L shaped movement. However, when, for example, an enlarged image is displayed on the display panel 11, it is sometimes preferred to move it not only in the vertical or horizontal direction but also in an oblique direction. To meet such requirement, for example, a left oblique upward movement of an image can be realized by simultaneously operating two points (Pa, Pb), as shown in FIG. 9. If it is troublesome to press the two positions at the same time, an L-shaped operation may be attained by pressing two points. For example, to attain a left oblique upward movement, the user touches the left end and upper end at the same time. However, it is relatively difficult to attain this operation using the right hand. In this case, when an L-shaped operation is made, as shown in FIG. 10, the same operation equivalent to that for simultaneously touching the left end (A2 region) and upper end (A1 region) can be attained. Also, after the tracing operation, when the finger is kept placed at the terminal end of tracing, it can be considered as a continuous operation. Of course, the operation of the touch pad can be translated into movement of an image on a display in any manner desired.

In this manner, since the touch pad structure of this embodiment limits operations to the vertical and horizontal directions, the correspondence between the operation inputs of the touch pad 12 and the responses on the window becomes easier to understand, thus preventing operation errors.

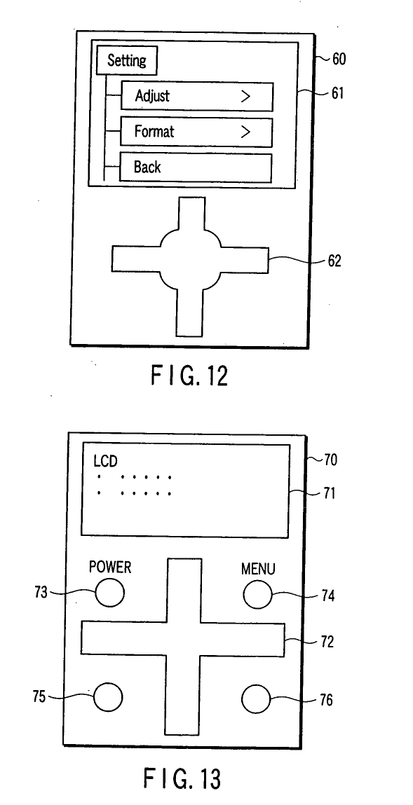

FIGS. 12 to 16 show second to sixth embodiments of the present invention. FIG. 12 is a front view showing an example of the arrangement of an electronic apparatus of the second embodiment. As shown in FIG. 12, the electronic apparatus of the second embodiment comprises a display panel 61 and touch pad 62 on the front surface of a housing 60. The touch pad 62 has a cross-shaped operation surface formed with a central circular region. The touch pad 62 allows pointing operations in all directions like a pointing stick (AccuPoint) by operating the central circular region in addition to the aforementioned operation input function of the first embodiment. The elongated elements of touch pad 62 appear to have an elliptical shape, with the major axis of each ellipse aligned with the axis of each elongated element. The elongated elements can be more closely elliptical in shape.

FIG. 13 is a front view showing an example of the arrangement of an electronic apparatus of the third embodiment. As shown in FIG. 13, the electronic apparatus of the third embodiment comprises a display panel 71 and a touch pad 72 having a cross-shaped operation surface on the front surface of a housing 70. Furthermore, the electronic apparatus has various operation buttons 73 to 76 between the horizontally and vertically extending operating surface portions of the touch pad 72. As shown in FIG. 13, with this pad structure, various input/output devices can be laid out on a free space of the touch pad 72 with the cross-shaped operation surface on the front surface of the housing 70, thus further attaining a size reduction of a portable apparatus.

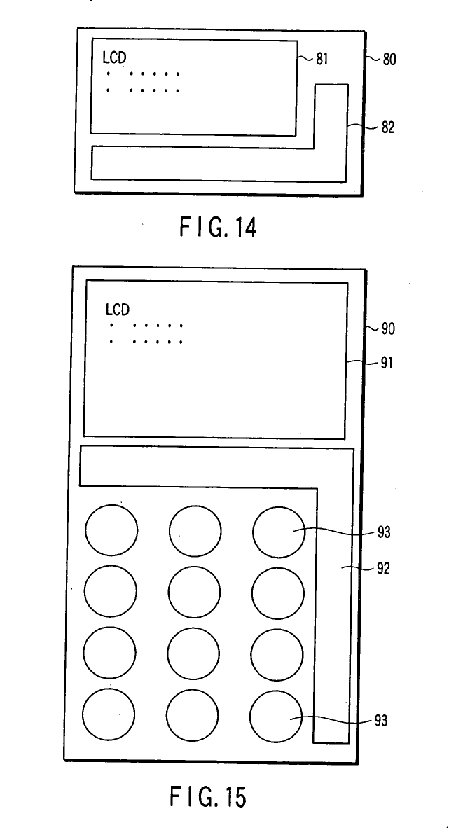

Furthermore, FIG. 14 is a front view showing an example of the arrangement of an electronic apparatus of the fourth embodiment. As shown in FIG. 14, the electronic apparatus of the fourth embodiment comprises a display panel 81 and a touch pad 82 having an L-shaped operation surface on the front surface of a housing 80. As in the first embodiment, the user can intuitively make up/down (back/forth) and right/left two-dimensional cursor instruction operations on the operation window of the display panel 81. Also, the touch pad can be realized by a small number of sensor arrays in terms of the structure. Furthermore, the mounting area occupied by the touch pad 82 on the front surface of the housing can be minimized.

FIG. 15 is a front view showing an example of the arrangement of an electronic apparatus of the fifth embodiment. As shown in FIG. 15, the electronic apparatus of the fifth embodiment comprises a display panel 91 and a touch pad 92 having an L-shaped operation surface on the front surface of a housing 90. Furthermore, the electronic apparatus has a plurality of various operation buttons 93 between the horizontally and vertically extending operation surface portions of the touch pad 92. With this pad structure as well, various input/output devices can be laid out on a free space of the touch pad 92 with the L-shaped operation surface on the front surface of the housing 90, thus further attaining a size reduction of a portable apparatus.

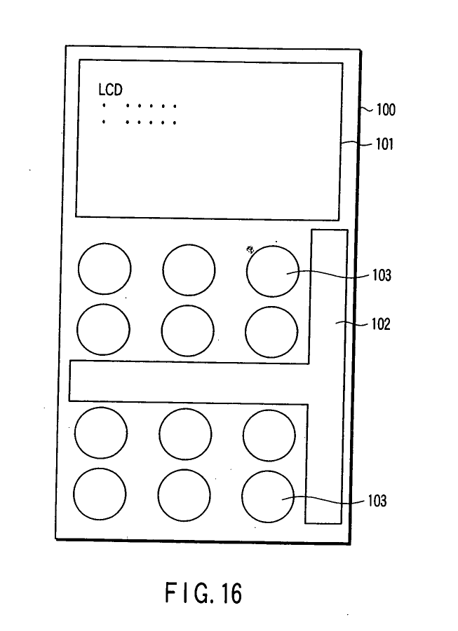

Moreover, FIG. 16 is a front view showing an example of the arrangement of an electronic apparatus of the sixth embodiment. As shown in FIG. 16, the electronic apparatus of the sixth embodiment comprises a display panel 101 and a touch pad 102 having a T-shaped operation surface on the front surface of a housing 100. Furthermore, the electronic apparatus has a plurality of various operation buttons 103 between the horizontally and vertically extending operation surface portions of the touch pad 102. With this pad structure as well, various input/output devices can be laid out on a free space of the touch pad 102 with the T-shaped operation surface on the front surface of the housing 100, thus further attaining a size reduction of a portable apparatus.

Note that the present invention is not limited to the arrangements of the aforementioned embodiments. For example, a pad structure in which the elongated operation surfaces of the touch pad have broad end portions, or the like, may be adopted. Also, the function, arrangement, and the like of the electronic apparatus are not limited to those in the aforementioned embodiments, and the present invention can be applied to various compact apparatuses, portable apparatuses, and the like without departing from the scope of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a touch pad having an operation surface formed by a first elongated surface and a second elongated surface which is contiguous with and transverse to the first surface;
a detection unit which detects a position and direction of operation on the operation surface of the touch pad; and
a display panel which displays the result of the detection unit.

2. An apparatus according to claim 1, wherein the operation surface has a cross shape, an L shape, or a T shape.

3. An apparatus according to claim 1, wherein the first surface has an elliptic shape having the extending direction of the first surface as a major axis direction, and the second surface has an elliptic shape having the extending direction of the second surface as a major axis direction.

4. An apparatus according to claim 1, wherein the touch pad and the display panel are arranged on a front surface of a low-profile box-shaped housing.

5. An apparatus according to claim 4, wherein operation buttons are laid out between the first and second surfaces of the touch pad on the front surface of the housing.

6. An apparatus according to claim 1, wherein the detection unit detects positions on the operation surface of the touch pad.

7. An apparatus according to claim 6, wherein the detection unit counts touch operations on the operation surface of the touch pad.

8. An apparatus according to claim 6, wherein the detection unit detects a direction of movement on the operating surface of the touch pad.

9. An apparatus according to claim 8, wherein the detection unit also detects an amount of movement on the operation surface of the touch pad.

10. An apparatus according to claim 8, wherein the detection unit also detects a moving speed on the operation surface of the touch operations.

11. An apparatus according to claim 8, wherein the operation surface is divided into a plurality of regions extending in different directions from a joint portion of the first and second surfaces, and a region formed on the joint portion, and
the detection unit detects movement between respective regions.

12. A touch pad device used in an electronic apparatus, comprising:
a touch pad having an operation surface formed by a first elongated surface, and a second elongated surface which is contiguous with and transverse to the first surface.

13. A device according to claim 12, wherein the first surface has an elliptic shape having the extending direction of the first surface as a major axis direction, and the second surface has an elliptic shape having the extending direction of the second surface as a major axis direction.
